(19) United States
(12) Patent Application Publication
(10) Pub. No.: US 2025/0168582 A1
(43) Pub. Date: May 22, 2025

(54) APPARATUS AND METHOD FOR ENHANCING SURROUND SOUND IN MULTI CHANNEL SPEAKER ENVIRONMENT

(71) Applicant: SAMSUNG ELECTRONICS CO., LTD., Suwon-si (KR)

(72) Inventors: Gurmanjeet Singh SIDHU, Punjab (IN); Vishal SHARMA, Delhi (IN); Anand Kumar ASATI, Greater Noida (IN)

(73) Assignee: SAMSUNG ELECTRONICS CO., LTD., Suwon-si (KR)

(21) Appl. No.: 19/029,939

(22) Filed: Jan. 17, 2025

Related U.S. Application Data
(63) Continuation of application No. PCT/KR2023/004903, filed on Apr. 12, 2023.

(30) Foreign Application Priority Data
Sep. 19, 2022 (IN) 202211053583

(51) Int. Cl. H04S 7/00

(52) U.S. Cl. CPC H04S 7/302

(57) ABSTRACT

A method for enhancing surround sound in an environment of a plurality of speakers is disclosed. The method includes generating a position map of the plurality of speakers based on respective position coordinates of each of the plurality of speakers; determining one or more equalized audio channels associated with each of the plurality of speakers, wherein the one or more equalized audio channels indicate homogeneous frequencies associated with each of the plurality of speakers; allocating the one or more equalized audio channels to one or more of the plurality of speakers based on the position map; and adjusting an audio intensity of the plurality of speakers based on the position map.

### CROSS-REFERENCES TO RELATED APPLICATIONS

This application is a continuation of International Application No. PCT/KR2023/004903, filed on Apr. 12, 2023, with the Korean Intellectual Property Office, which claims priority from Indian patent application Ser. No. 202211053583, filed on Sep. 19, 2022, with the Indian Intellectual Property Office, the disclosures of which are incorporated by reference herein in their entireties.

### TECHNICAL FIELD

The present disclosure relates to cybernetics and more particularly, to a system, apparatus and a method for enhancing surround sound in an environment of speakers.

### BACKGROUND

In our home or even in commercial spaces offering entertainment, users may prefer to enjoy high-quality sound, for example in home entertainment systems, users may prefer to use multiple speakers for providing stereo, surround sound, and other high-fidelity sounds. For an immersive entertainment experience, users may prefer a professional sound system, which may provide enhanced surround sound even in the comfort of home. A surround sound setup provides an audio listening experience that adds a bit of excitement when watching action movies or playing video games.

The surround sound setup sounds installed in the user's premises may include user equipment configured to playback music and transmit the audio signal to speakers for playback. Such a setup may be capable of providing surround sound and the user may experience movies, or any other sound-based entertainment the way they were meant to be enjoyed. Depending on the surround sound setup the user may choose, speakers may be installed all around a room forming an environment.

In a multi-channel, multi-speaker environment, the audio listening experience is not controlled according to the master device's position or orientation within the 3D space. Also, each speaker may have different characteristics and capabilities such as sensitivity, gain, power, frequency response, etc. which may give a poor listening experience to the user. If the speaker is not positioned as per its correct position, say the left speaker is placed with the error of 10° counterclockwise, it may lead to a poor audio listening experience. Furthermore, the user equipment may be connected to multiple speakers installed at different positions and orientations in the room. It may be possible that the rotation of the master device at its position produces audio lag while delivering audio to speakers, thus, again providing a poor audio listening experience to the user.

The existing technology has failed to provide a solution to produce surround sound with homogeneity. When the user equipment is rotating at its position in 3D Space, the audio signal is delivered to corresponding speakers acting as slave devices in a multi-speaker environment, with multiple orientations, position, distance, speaker characteristics, capability, multiple user equipment orientations, audio lag, may eventually lead to poor surround sound audio listening effect.

Therefore, there is a need for a system, an apparatus and method to produce homogeneous audio signals in a multi-channel speaker environment.

### SUMMARY

This technical solution is provided to introduce a selection of concepts, in a simplified format, that are further described in the detailed description of the present disclosure. This technical solution is neither intended to identify key or essential inventive concepts of the present disclosure nor is it intended for determining the scope of the present disclosure.

In an embodiment of the present disclosure, a method for enhancing surround sound in an environment of a plurality of speakers is disclosed. The method includes generating a position map of the plurality of speakers based on respective position coordinates of each of the plurality of speakers; determining one or more equalized audio channels associated with each of the plurality of speakers, wherein the one or more equalized audio channels indicate homogeneous frequencies associated with each of the plurality of speakers; allocating the one or more equalized audio channels to one or more of the plurality of speakers based on the position map; and adjusting an audio intensity of the plurality of speakers based on the position map.

In an embodiment of the present disclosure, a user equipment (UE) for enhancing surround sound in an environment of a plurality of speakers is provided. The UE may include at least one processor and memory storing one or more instructions, when executed by the at least one processor individually or collectively, cause the UE to: generate a position map of the plurality of speakers based on respective position coordinates of the plurality of speakers, determine one or more equalized audio channels associated with each of the plurality of speakers, wherein the one or more equalized audio channels indicate a homogeneous frequencies associated with each of the plurality of speakers, allocate the one or more equalized audio channels to one or more of the plurality of speakers based on the position map, and adjust an audio intensity of the plurality of speakers based on the position map.

In an embodiment of the present disclosure, a non-transitory computer readable medium storing instructions is provided. The instructions, when executed by at least one processor individually or collectively, cause an electronic device to: generate a position map of the plurality of speakers based on respective position coordinates of each of the plurality of speakers, determine one or more equalized audio channels associated with each of the plurality of speakers, wherein the one or more equalized audio channels indicate a homogeneous frequencies associated with each of the plurality of speakers, allocate the one or more equalized audio channels to one or more of the plurality of speakers based on the position map, and adjust an audio intensity of the plurality of speakers based on the position map. In an embodiment of the present disclosure, a computer readable medium instructions that, when executed, cause at least one processor of an electronic device to perform operations corresponding to the method for enhancing surround sound in an environment of a plurality of speakers is provided.

To further clarify the advantages and features of the present disclosure, a more particular description of the present disclosure will be rendered by reference to specific embodiments thereof, which is illustrated in the appended drawings. It is appreciated that these drawings depict only typical embodiments of the present disclosure and are therefore not to be considered limiting of its scope. The present disclosure will be described and explained with additional specificity and detail with the accompanying drawings.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 illustrates a block diagram depicting an environment of implementation of a system for enhancing surround sound, according to an embodiment of the present disclosure;

FIG. 2 illustrates a block diagram of the system for enhancing surround sound, according to an embodiment of the present disclosure;

FIG. 3 illustrates a flowchart depicting a method for enhancing surround sound, according to an embodiment of the present disclosure;

FIG. 4 illustrates an exemplary scenario for generating the position map of each of the speakers according to an embodiment of the present disclosure;

FIG. 5 illustrates a flowchart depicting a method for enhancing surround sound, according to an embodiment of the present disclosure;

FIG. 6 illustrates a flowchart depicting a method for enhancing surround sound, according to an embodiment of the present disclosure; and

FIG. 7 illustrates a block diagram of the user equipment (UE) for enhancing surround sound, according to an embodiment of the present disclosure.

Further, skilled artisans will appreciate that elements in the drawings are illustrated for simplicity and may not have necessarily been drawn to scale. For example, the flow charts illustrate the method in terms of the most prominent steps and/or operations involved to help to improve understanding of aspects of the present disclosure. Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having the benefit of the description herein.

### DETAILED DESCRIPTION

For the purpose of promoting an understanding of the principles of the present disclosure, reference will now be made to the embodiments illustrated in the drawings and specific language will be used to describe the same. It will nevertheless be understood that no limitation of the scope of the present disclosure is thereby intended, such alterations and further modifications in the illustrated system, and such further applications of the principles of the present disclosure as illustrated therein being contemplated as would normally occur to one skilled in the art to which the invention relates. Unless otherwise defined, all technical and scientific terms used herein have the same meaning as commonly understood by one of ordinary skilled in the art to which the present disclosure belongs. The system, apparatus, methods, and examples provided herein are illustrative only and not intended to be limiting.

For example, the term “some” as used herein may be understood as “none” or “one” or “more than one” or “all.” Therefore, the terms “none,” “one,” “more than one,” “more than one, but not all” or “all” would fall under the definition of “some.” It should be appreciated by a person skilled in the art that the terminology and structure employed herein are for describing, teaching, and illuminating some embodiments and their specific features and elements and therefore, should not be construed to limit, restrict, or reduce the spirit and scope of the present disclosure in any way.

For example, any terms used herein such as, “includes,” “comprises,” “has,” “consists,” and similar grammatical variants do not specify an exact limitation or restriction, and certainly do not exclude the possible addition of one or more features or elements, unless otherwise stated. Further, such terms must not be taken to exclude the possible removal of one or more of the listed features and elements, unless otherwise stated, for example, by using the limiting language including, but not limited to, “must comprise” or “needs to include.”

Whether or not a certain feature or element was limited to being used only once, it may still be referred to as “one or more features” or “one or more elements” or “at least one feature” or “at least one element.” Furthermore, the use of the terms “one or more” or “at least one” feature or element does not preclude there being none of that feature or element, unless otherwise specified by limiting language including, but not limited to, “there needs to be one or more . . . ” or “one or more element is required.”

Unless otherwise defined, all terms, and especially any technical and/or scientific terms, used herein may be taken to have the same meaning as commonly understood by a person ordinarily skilled in the art.

Reference is made herein to some “embodiments.” It should be understood that an embodiment is an example of a possible implementation of any features and/or elements of the present disclosure. Some embodiments have been described for the purpose of explaining one or more of the potential ways in which the specific features and/or elements of the proposed disclosure fulfil the requirements of uniqueness, utility, and non-obviousness.

Use of the phrases and/or terms including, but not limited to, “a first embodiment,” “a further embodiment,” “an alternate embodiment,” “one embodiment,” “an embodiment,” “multiple embodiments,” “some embodiments,” “other embodiments,” “further embodiment”, “furthermore embodiment”, “additional embodiment” or other variants thereof do not necessarily refer to the same embodiments. Unless otherwise specified, one or more particular features and/or elements described in connection with one or more embodiments may be found in one embodiment, or may be found in more than one embodiment, or may be found in all embodiments, or may be found in no embodiments.

Although one or more features and/or elements may be described herein in the context of only a single embodiment, or in the context of more than one embodiment, or in the context of all embodiments, the features and/or elements may instead be provided separately or in any appropriate combination or not at all. Conversely, any features and/or elements described in the context of separate embodiments may alternatively be realized as existing together in the context of a single embodiment.

Any particular and all details set forth herein are used in the context of some embodiments and therefore should not necessarily be taken as limiting factors to the proposed disclosure.

Embodiments of the present disclosure will be described below in detail with reference to the accompanying drawings.

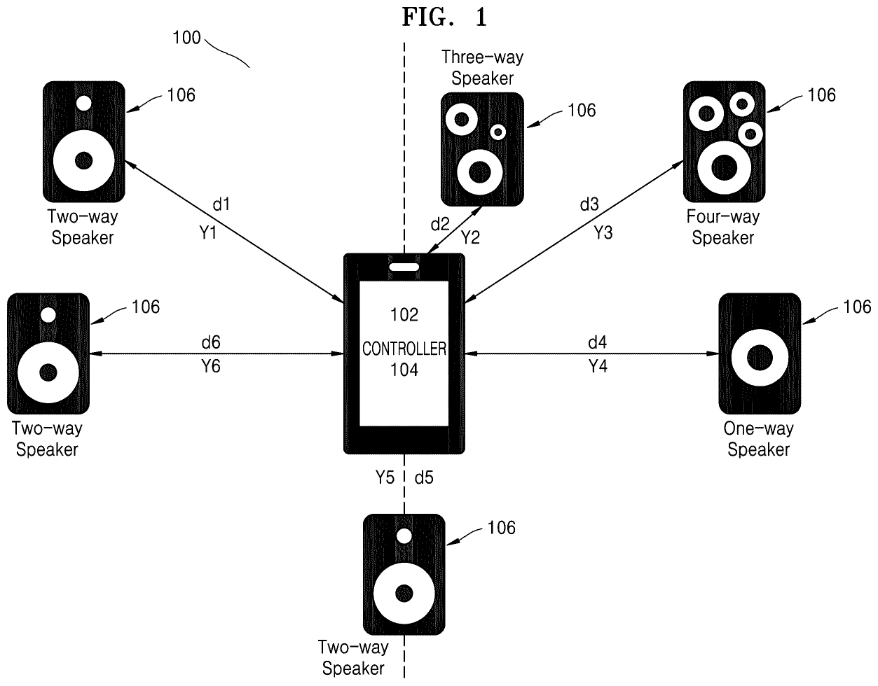

FIG. 1 illustrates a block diagram depicting an environment of implementation of a system 100 for enhancing surround sound in an environment comprising multiple speakers, according to an embodiment of the present disclosure. For the sake of brevity, the system 100 for enhancing surround sound is hereinafter interchangeably referred to as the system 100.

In an embodiment of the present disclosure, the system 100 includes a user equipment (UE) 102, a plurality of speakers 106. The UE 102 and the plurality of speakers 106 may be residing in a residential premise or a commercial premise forming an environment to provide an audio listening experience when the UE 102 transmits the audio signals to the plurality of speakers 106 for playback.

In an embodiment, the UE 102 is configured to transmit audio signals to one or more the plurality of speakers 106 and may receive data as well from one or more of the plurality of speakers 106. The UE 102 may include a controller 104 configured to perform various operations enabling playback of sound in one or more of the plurality of speakers 106. In an example, the UE 102 may be but is not limited to a laptop, a mobile phone, a PDA (Personal Digital Assistant), a smartphone, a multimedia device, a wearable device, etc.

In an embodiment, the speakers 106 are an apparatus for converting electrical impulses transmitted as audio files by the UE 102 into sound. The speakers 106 may be installed in the environment surrounding the UE 102 and may be distributed within an enabling playback range of the UE 102. In an example, the speakers 106 may constitute multiple types of speakers 106, installed at different angles, different angular positions, variable distances from the UE 102, multiple configuration, and orientations. In the example, the system 100 may include multiple types of speakers 106 listed in Table 1.

TABLE 1

| SPEAKERS 106 | DISTANCE FROM UE | |
|---|---|---|
| CONFIGURATION | 102 | SIGNAL |
| Two-way Speaker | d1 | Y1 |
| Three-way Speaker | d2 | Y2 |
| Four-way Speaker | d3 | Y3 |
| One-way Speaker | d4 | Y4 |
| Two-way Speaker | d5 | Y5 |
| Two-way Speaker | d6 | Y6 |

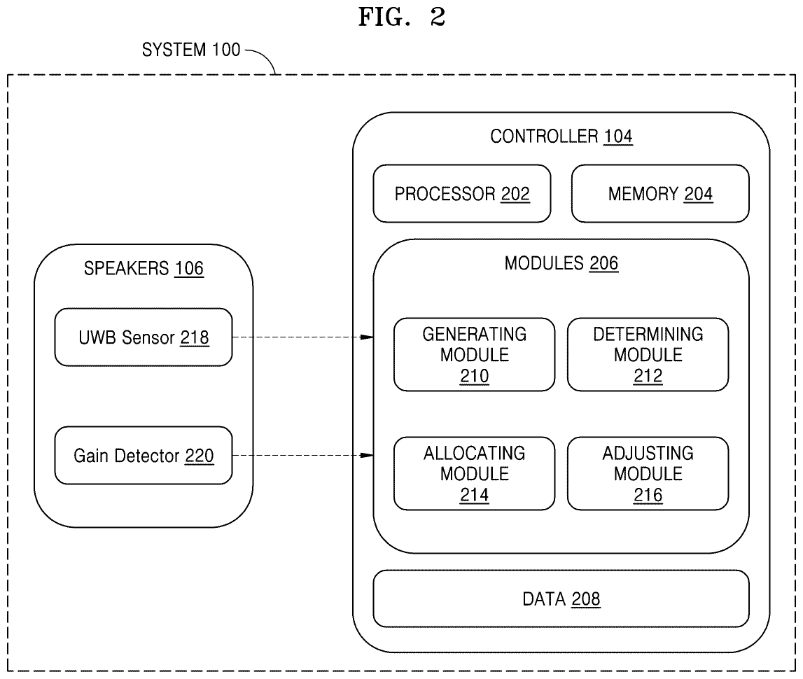

FIG. 2 illustrates a block diagram of the system 100 for enhancing surround sound, according to an embodiment of the present disclosure.

In an embodiment, the speakers 106 may include an ultra-wide bandwidth (UWB) sensor 218 and a speaker gain detector 220. The UWB sensor 218 and the speaker gain detector 220 are in communication with the controller 104 of the UE 102.

In an embodiment, the system 100 may include the controller 104 in communication with one or more of the plurality of speakers 106. The controller 104 may include but is not limited to, a processor 202, memory 204, modules 206, and data 208. The modules 206 and the memory 204 may be coupled to the processor 202.

The processor 202 can be a single processing unit or several units, all of which could include multiple computing units. The processor 202 may be implemented as one or more microprocessors, microcomputers, microcontrollers, digital signal processors, central processing units, state machines, logic circuitries, and/or any devices that manipulate signals based on operational instructions. Among other capabilities, the processor 202 is adapted to fetch and execute computer-readable instructions and data stored in the memory 204.

The memory 204 may include any non-transitory computer-readable medium known in the art including, for example, volatile memory, such as static random-access memory (SRAM) and dynamic random access memory (DRAM), and/or non-volatile memory, such as read-only memory (ROM), erasable programmable ROM, flash memories, hard disks, optical disks, and magnetic tapes.

The modules 206, amongst other things, include routines, programs, objects, components, data structures, etc., which perform particular tasks or implement data types. The modules 206 may also be implemented as, signal processor(s), state machine(s), logic circuitries, and/or any other device or component that manipulates signals based on operational instructions.

Further, the modules 206 can be implemented in hardware, instructions executed by a processing unit, or by a combination thereof. The processing unit can comprise a computer, a processor, such as the processor 202, a state machine, a logic array, or any other suitable devices capable of processing instructions. The processing unit can be a general-purpose processor which executes instructions to cause the general-purpose processor to perform the required tasks or, the processing unit can be dedicated to performing the required functions. In another embodiment of the present disclosure, the modules 206 may be machine-readable instructions (software), which when executed by a processor/processing unit, perform any of the described functionalities.

In an embodiment, the modules 206 may include a generating module 210, a determining module 212, an allocating module 214, and an adjusting module 216. The generating module 210, the determining module 212, the allocating module 214, and the adjusting module 216 may be in communication with each other. The data 208 serves, amongst other things, as a repository for storing data processed, received, and generated by one or more of the modules 206.

Referring to FIG. 1 and FIG. 2, the generating module 210 may be configured to generate a position map of the plurality of speakers based on the position coordinates (xn, yn, zn) of the plurality of speakers 106, wherein ‘n’ is an integer and can be from 1 to the total number of the speakers 106 in the environment. The position map of the speakers 106 may be indicative of the precise location of the speakers 106 in the environment.

In an embodiment, the generating module 210 may be in communication with the UWB sensor 218 and is configured to obtain from the UWB sensor 218 an UWB data. In an example, the UWB data may include a Yaw angle, an arrival angle (i.e., a pitch angle) and distance information. Yaw angle means the rotation angle around the z-axis, and pitch angle means the rotation angle around the y-axis. In the example, the arrival angle may be calculated based on the Yaw angle and distance of each of the plurality of speakers 106 from the UE 102. In the example, the UWB data including the Yaw angle, the arrival angle, and the distance are transmitted from the speakers 106 to the UE 102.

In the example, the Yaw angle, the arrival angle, and the distance are then interpreted to determine the position i.e., the position coordinates of each of the plurality of speakers 106 in the environment. The position is determined using the following formula (1).

$${Matrix}_{coordinates in Current Orientation} = [ \begin{matrix}d cos ( β n ) cos ( α n ) \\ d cos ( β n ) cos ( α n ) \\ d sin ( β n )\end{matrix} ] = [ \begin{matrix}xn \\ yn \\ zn\end{matrix} ] \qquad ( 1 )$$

In the formula (1), the angle αn is the Yaw angle, the angle βn is arrival angle, and the distance dn is the straight-line distance from the UE 102 to the each of the speakers 106, wherein ‘n’ is an integer and can be from 1 to the total number of the speakers 106 in the environment. The position coordinates (xn, yn, zn) of the speakers 106 are calculated by the generating module 210 based on αn, βn and distance dn of the speakers 106 received from UWB sensor 218 of the speakers 106.

Further, the position map is generated using the determined position coordinates (xn, yn, zn) and based on an orientation of the UE 102. Such that, the position map helps in determining which of the speakers 106 are placed in the front of the UE 102, sideways of the UE 102, backside of the UE 102, or any other positional coordinate surrounding the UE 102. In the example, the position map may be altered if the UE 102 varies its orientation.

The generating module 210 is in communication with the determining module 212.

In an embodiment, the determining module 212 is configured to determine equalized audio channels for each of the speakers 106 in the environment. In an embodiment, the equalized audio channels may be indicative of a homogeneous frequency configured for each of the speakers 106.

In an example, the determining module 212 is configured to create a chirp sound signal (x) or known as exponential chirp to be played on the speakers 106 and compute an inverse logarithmic signal (x′) for cross-correlation to determine the equalized audio channels for each of the speakers 106 in the environment. In an example, the chirp sound signal (x) may range from 20 Hz to 20 KHz and may be a logarithmic signal, linear signal, or any other signal.

The chirp sound signal (x) may be produced as the following formula (2) and formula (3).

$$k = {( \frac{{f}_{2}}{{f}_{1}} )}^{\frac{1}{T}} \qquad ( 2 )$$

$$x ( t ) = sin ( 2 π {f}_{1} ( \frac{{k}^{t} - 1}{ln ( k )} ) ) \qquad ( 3 )$$

In the formula (2), f1 is starting frequency (e.g. 20 Hz), f2 is ending frequency (e.g. 20 KHz), and T is chirp duration. Further, as the chirp sound signal (x) is played in the speakers 106, the determining module 212 is configured to record an output signal (Y1, Y2, Y3 . . . Yn) for each of the speakers 106 based on the chirp sound signal (x). The determining module 212 is configured to process the inverse logarithmic chirp (x′) to filter the logarithmic chirp sound signal (x) with discrete convolution to produce inter-correlation frequency data Y1′ to Yn′. ‘n’ is an integer and can be from 1 to the total number of the speakers 106 in the environment.

The inverse logarithmic chirp (x′) may be calculated using the following formula (4).

$${x}^{′} ( t ) = sin ( 2 π {f}_{1} ( \frac{{k}^{τ - t} - 1}{ln ( k )} ) ) \qquad ( 4 )$$

Further, the determining module 212 is configured to calculate an inter-correlation frequency data Y1′ to Yn′ based on the output signal Y1 to Yn for each of the speakers 106.

In an example, the inter-correlation frequency data Y1′ to Yn′ may be calculated by performing Fourier transformation of the output signal (Y1, Y2, Y3 . . . Yn) for each of the speakers 106. The inter-correlation frequency data Y1′ to Yn′ may be calculated using the following formula (5). ‘n’ is an integer and can be from 1 to the total number of the speakers 106 in the environment.

$${Y}^{′} ( t ) = ( Y * {x}^{′} ) [ n ] = {\sum }_{m = - ∞}^{∞} Y [ m ] {x}^{′} [ n - m ] \qquad ( 5 )$$

Thereafter, the determining module 212 take the difference in frequency amplitude for each frequency. If the difference crosses predefined threshold δ, then introduce a notch filter for that frequency. The notch filter is used to remove a single frequency or a narrow band of frequencies. In audio systems, a notch filter can be used to remove interfering frequencies such as powerline hum. The notch filter can also be used to remove a specific interfering frequency in radio receivers and software-defined radio.

In the example, then the determining module 212 club all the notch filters to create an inverted comb-like signal (Z) to remove non-homogeneous frequencies. The inverted comb-like signal (Z) represents the determined equalized audio channels based on the calculated inter-correlation frequency data. Such that, the equalized audio channels is the homogeneous frequencies between each of the speakers 106.

In an embodiment, the homogeneous frequencies may be played as an audio signal on all the speakers 106 present in the environment and unwanted frequencies are suppressed in each of the speakers 106 in the environment. Thus, the determined equalized audio channels for each of the speakers 106 acts as an equalizer for all the channels in the audio input.

In an embodiment, once the determining module 212 find out all the rejected frequencies which cannot be played by each of the speakers 106. The determining module 212 applies the transfer function H(s) (refers to formula (6)) to remove all the rejected frequencies. Removing specific frequencies is from signal is just like band selective pass filter which allows only some frequencies to pass, here most of the frequencies are passed but only some are rejected. In the formula (6), wo is central reject frequency and wc is width of rejected band.

$$H ( s ) = \frac{{s}^{2} + {w}_{0}^{2}}{{s}^{2} + {w}_{c} s + {w}_{0}^{2}} \qquad ( 6 )$$

The generating module 210, and the determining module 212 may be in communication with the allocating module 214.

In an embodiment, the allocating module 214 is configured to allocate the equalized audio channels to the speakers 106 based on the position map to enhance the surround sound.

In an example, the allocating module 214 is configured to determine the number of channels in the environment for the speakers 106. Further, in an example, the allocating module 214 is configured to obtain a number of the speakers 106 present in the environment and an angular position of each of the plurality of speakers 106 with respect to the UE 102. The angular position may be obtained from the position map as the Yaw angle and the arrival angle of each of the plurality of speakers 106.

The allocating module 214 is configured to determine a function for each of the speakers 106. In an example, the function for each of the speakers 106 indicates configuration, which is the orientation function of the speakers 106. In an example, the function is determined based on the determined number of channels and the obtained angular position of the speakers 106.

In an example, the orientation function is different for each of the speakers 106, based on the orientation function, the allocating module 214 decide what intensity of each channels is played on each speakers 106. Using the angular position of the speakers 106, the allocating module 214 find out the nearest channels of each speakers 106 in cylindrical coordinate environment, then orientation function is made by resolution of channels in orientation of each speakers 106.

In an embodiment, the allocating module 214 is configured to allocate each of the equalized audio channels proportionally to each of the plurality of speakers 106 in the environment based on the position map and based on the orientation function to know the output for each plurality of speakers 106. In an example, one channel data may be allocated to more than one speaker among the plurality of speakers 106, and/or one speaker among the plurality of speakers 106 may receive data from more than one channel. In an example, the allocating module 214 may consider the equalized audio channels as vectors and resolve them by considering speakers' is x-axis of that cylindrical coordinate environment with UE 102 as origin. Thus, the UE 102 enhances the surround sound based on the function for each of the speakers 106.

The generating module 210, the determining module 212, and the allocating module 214 may be in communication with the adjusting module 216.

In an embodiment, the adjusting module 216 is configured to adjust the audio intensity of each of the speakers 106 based on the position map to enhance the surround sound in the environment.

In an example, the adjusting module 216 may be in communication with a speaker gain detector 220. The adjusting module 216 may be configured to determine a gain value for each of the plurality of speakers 106 through data obtained from the speaker gain detector 220.

Further, the adjusting module 216 in communication with the generating module 210 is configured to obtain the distance of each of the speakers 106 in the environment from the UE 102.

In an example, the adjusting module 216 is configured to calculate an audio intensity for each of the speakers 106, based on the determined gain value and the distance obtained.

In an example, the audio intensity I(n) for each of the plurality of speakers 106 may be calculated using the following formula (7). ‘n’ is an integer and can be from 1 to the total number of the speakers 106 in the environment.

$$I ( n ) = Ical ( n ) {( \frac{dcal ( n )}{d ( n )} )}^{2} \qquad ( 7 )$$

In the above formula (7), Ical(n) is intensity of each speakers 106 at time of calibration. When chirp signal is played on each speakers 106 one by one, the intensity of each speakers 106 may be known based on the determined gain values of each speakers 106, and that values of the intensity are Ical(n). Also dcal(n) is distance of each speakers 106 from the UE 102 at that time. I(n) is the intensity at which each speakers 106 can play at current distance d(n).

In an example, the adjusting module 216 is configured to adjust the audio intensity for each of the speakers 106 in the environment. The adjusting module 216 adjust the amplitude of the output for each speakers 106 so that all speakers 106 may play sound at similar levels. The audio intensity is adjusted for each of the plurality of speakers 106 using the following formula (8). ‘n’ is an integer and can be from 1 to the total number of the speakers 106 in the environment.

$${I}^{′} ( n ) = \frac{Kcal ( n )}{{d}^{2}} , \qquad ( 8 )$$

$$where$$

$$Kcal ( n ) = {I}^{′} cal ( n ) \times {d}^{′} cal {( n )}^{2}$$

In the above formula (8), I′(n) is the adjusted audio intensity. Kcal(n) is constant for each speakers 106, once calibrated. I′cal(n) is intensity of each speakers 106 at time of calibration, and d′cal(n) is distance of each speakers 106 from the UE 102 at that time. I′cal(n) can be same with the Ical(n) and d′cal(n) can be same with the dcal(n).

In the example, post adjusting the audio intensity for each of the speakers 106 it is required that the audio intensity becomes equal for each of the speakers 106 in the environment. Thus, the UE 102 enhances surround sound in the environment consisting of multiple speakers 106.

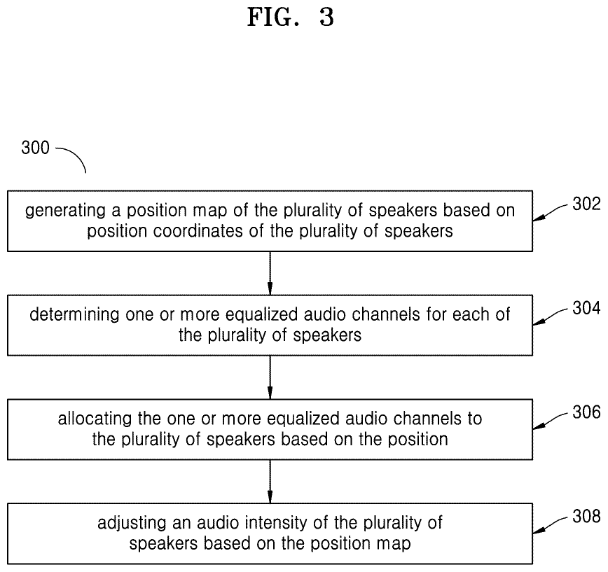

FIG. 3 illustrates a flowchart depicting a method 300 for enhancing surround sound, according to an embodiment of the present disclosure. The method 300 may be a computer-implemented method executed, for example, by the controller 104. For the sake of brevity, constructional and operational features of the system 100 that are already explained in the description of FIG. 1, and FIG. 2, are not explained in detail in the description of FIG. 3.

At operation 302, the method 300 may include generating the position map of the speakers 106 based on respective position coordinates of each of the plurality of speakers 106.

In the method 300, to generate the position map, the UE 102 may obtain the UWB data via ultra-wide bandwidth (UWB) sensor 218 of each of the speakers 106. In an example, each of the speakers 106 may contain the UWB sensor 218 installed respectively.

Further, in the method 300, the UE 102 may calculate an angle of arrival and a distance of each of the speakers 106 based on the UWB data obtained. The method 300 includes determining the position coordinates of each of the speakers 106 in the environment based on the angle of arrival and the distance of each of the plurality of the speakers 106. Thus, the UE 102 may generate the position map by providing coordinates (xn, yn, zn) of each of the speakers 106 in the environment. In an embodiment, the position map is generated based on an orientation of the UE 102 being connected with the plurality of speakers 106 for transmitting a sound signal.

At operation 304, the method 300 may include determining one or more equalized audio channels associated with each of the plurality of speakers 106. In an example, the equalized audio channels may indicate the homogeneous frequencies configured for/associated with each of the speakers 106 by suppressing the unwanted frequencies.

In the method 300, a chirp sound signal is played by each of the speakers 106. The UE 102 may produce/create chirp sound signals to be played on each of the plurality of speakers 106. The UE 102 control the each of the plurality of speakers 10 to play the chirp sound signals. The chirp sound signals may be ranging from 20 Hz to 20 KHz. Further, The UE 102 may record output signals for each of the speakers 106 based on the chirp sound signals played.

In the method 300, the UE 102 may calculate an inter-correlation frequency data based on the output signals for each of the speakers 106. Further, the UE 102 may determine the equalized audio channels based on the calculated inter-correlation frequency data. In an example, the equalized audio channels may indicate the homogeneous frequencies between each of the plurality of speakers 106.

At operation 306, the method 300 may include allocating the one or more equalized audio channels to one or more of the plurality of speakers 106 based on the position map to enhance the surround sound.

The method 300 may include determining the number of channels available in the environment for the speakers 106. Further, the UE 102 may obtain or determine a number of the plurality of speakers and angular positions of the plurality of speakers 106 with respect to the UE 102.

In the method 300, the UE 102 may determine a function associated with each of the speakers 106 based on the number of channels and the angular positions of the plurality of speakers 106. In an example, the function may indicate the configuration, and orientation function of the speakers 106.

Further, in the method 300, the UE 102 may allocate each of the equalized audio channels proportionally to each of the plurality of speakers 106 to enhance the surround sound based on the function of each of the speakers 106 in the environment.

At operation 308, the method 300 may include adjusting the audio intensity of the plurality of speakers 106 based on the position map to enhance the surround sound.

In the method 300, the UE 102 may determine a respective gain value for each of the plurality of speakers 106 through the speaker gain detector 220. Further, the UE 102 may obtain the respective distance of each of the speakers 106.

The method 300 may include, calculating a respective audio intensity of each of the plurality of speakers 106, based on the respective gain value and the respective distance.

The respective audio intensity of each of the plurality of speakers 106 is then adjusted such that the audio intensity is equal for each of the plurality of speakers 106 in the environment.

In an embodiment, the homogeneous frequencies are played as an audio signal on each of the plurality of speakers present in the environment. In an embodiment, an unwanted frequency is suppressed in each of the plurality of speakers in the environment.

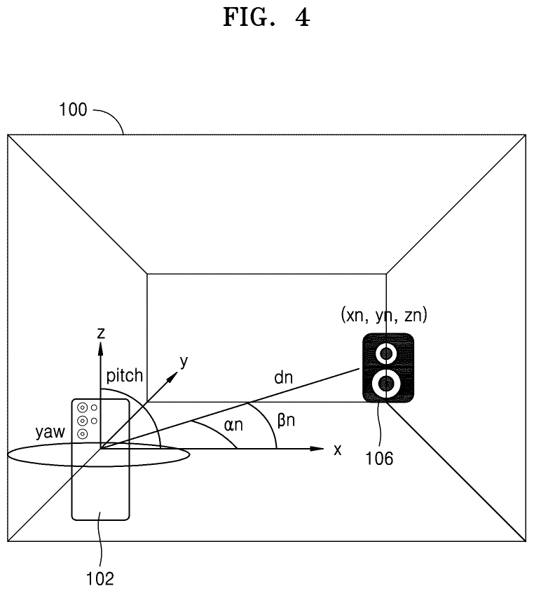

FIG. 4 illustrates the details of generating the position map of each of the speakers according to an embodiment of the present disclosure.

Referring to FIG. 4, the angle αn is the Yaw angle of each of the speakers 106, the angle βn is arrival angle of each of the speakers 106, and the distance dn is the straight-line distance from the UE 102 to the each of the speakers 106, wherein ‘n’ is an integer and can be from 1 to the total number of the speakers 106 in the environment. The UE 102 may receive αn, βn and distance dn of each of the speakers 106 from UWB sensor 218 of each of the speakers 106. The UE 102 may calculate the position coordinates (xn, yn, zn) of each of the speakers 106 based on received αn, βn and distance dn of each of the speakers 106.

Further, the UE 102 generate position map using the calculated position coordinates (xn, yn, zn) of each of the speakers 106 and based on an orientation of the UE 102. Such that, the position map helps in determining which of the speakers 106 are placed in the front of the UE 102, sideways of the UE 102, backside of the UE 102, or any other positional coordinate surrounding the UE 102. In the example, the position map may be altered if the UE 102 varies its orientation.

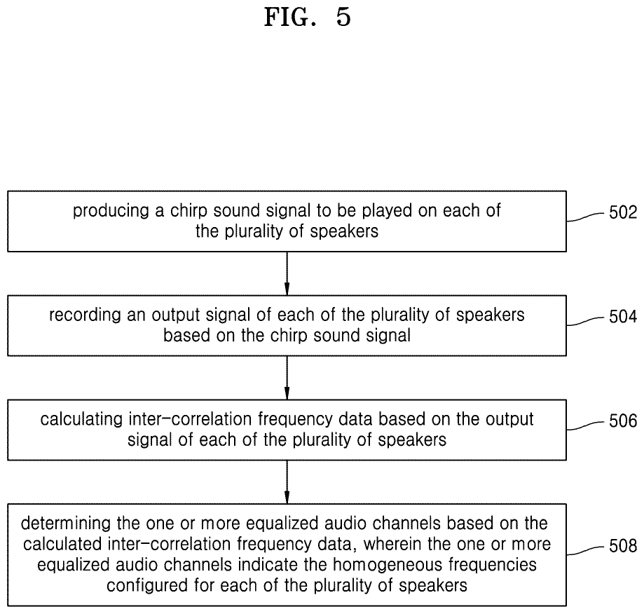

FIG. 5 illustrates a flowchart depicting a method for enhancing surround sound, according to an embodiment of the present disclosure.

Referring to FIG. 5, in operation 502, the UE 102 may produce/create chirp sound signals to be played on each of the plurality of speakers 106. The UE 102 may control the each of the plurality of speakers 106 to play the chirp sound signals. In operation 504, the UE 102 may record output signals of each of the plurality of speakers 106 based on the chirp sound signals. In operation 506, the UE 102 may calculate inter-correlation frequency data based on the output signals of each of the plurality of speakers 106. In operation 508, the UE 102 may determine the one or more equalized audio channels based on the calculated inter-correlation frequency data, wherein the one or more equalized audio channels indicate the homogeneous frequencies configured for/associated with each of the plurality of speakers 106. The above operations 502 to 508 may be operated by the determining module 212.

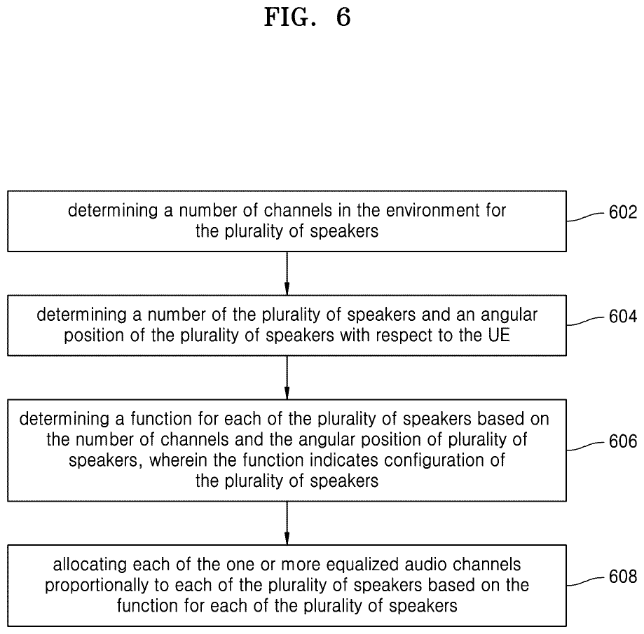

FIG. 6 illustrates a flowchart depicting a method for enhancing surround sound, according to an embodiment of the present disclosure.

Referring to FIG. 6, in operation 602, the UE 102 may determine a number of channels available in the environment for the plurality of speakers 106. In operation 604, the UE 102 may determine a number of the plurality of speakers 106 and a respective angular position of each the plurality of speakers 106 with respect to the UE 102. In operation 606, the UE 102 may determine a function associated with each of the plurality of speakers 106 based on the number of channels and angular positions of plurality of speakers. The function indicates a configuration of each of the plurality of speakers 106. The angular positions of the plurality of speakers comprises the respective angular position of each of the plurality of speakers with respect to the UE. In operation 608, the UE 102 may allocate the one or more equalized audio channels proportionally to one or more of the plurality of speakers 106 based on the function associated with each of the plurality of speakers 106. The above operations 602 to 608 may be operated by the allocating module 214.

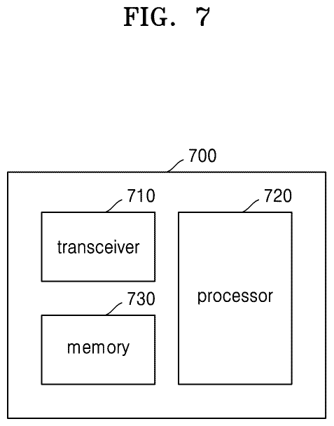

FIG. 7 illustrates a block diagram of the user equipment (UE) for enhancing surround sound, according to an embodiment of the present disclosure.

Referring to FIG. 7, an user equipment (700) according to an embodiment of the present disclosure include a transceiver (710), a processor (720) and a memory (730). However, all of the illustrated components are not essential. The user equipment (700) may be implemented by more or less components than those illustrated in FIG. 7. In addition, the processor (720) and the transceiver (710) and the memory (730) may be implemented as a single chip according to another embodiment.

The user equipment (700) may be a part of the system (100) in the present disclosure as the user equipment 102 in FIG. 1 of the present disclosure. The user equipment (700) may include the proposed generating module (210), the proposed determining module (212), the proposed allocating module (214) and the proposed adjusting module (216). The aforementioned generating module (210), determining module (212), allocating module (214) and adjusting module (216) may operate according to the method described in the present disclosure.

The aforementioned components will now be described in detail. The processor (720) may include one or more processors or other processing devices that control the proposed function, process and/or method and may be the controller 104 or processor 202 in in FIG. 1 of the present disclosure. Operation of the user equipment (700) aforementioned in this disclosure may be implemented by the processor (720). The processor (720) may generate a position map of the plurality of speakers based on the position coordinates of the plurality of speakers. The processor (720) may determine one or more equalized audio channels for each of the plurality of speakers, wherein the one or more equalized audio channels indicate a homogeneous frequencies configured for each of the plurality of speakers. The processor (720) allocate the one or more equalized audio channels to the plurality of speakers based on the position map. The processor (720) adjust the audio intensity of the plurality of speakers based on the position map.

The processor (720) may include one or a plurality of processors. In this case, the one or more processors may be a general-purpose processor such as a CPU, an AP, or a digital signal processor (DSP), a graphics-only processor such as a GPU or a vision processing unit (VPU), or an artificial intelligence-only processor such as an NPU. For example, when one or more processors are processors dedicated to artificial intelligence, the processors dedicated to artificial intelligence may be designed as a hardware structure specialized for processing a specific artificial intelligence model.

The processor (720) may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor (720) may include a combination of processors performing various of the recited/disclosed functions, e.g., in a distributed manner. At least one processor may execute program instructions to achieve or perform various functions.

The transceiver (710) may include a RF transmitter for up-converting and amplifying a transmitted signal, and a RF receiver for down-converting a frequency of a received signal. However, according to an embodiment, the transceiver (710) may be implemented by more or less components than those illustrated in components. The transceiver (710) may be connected to the processor (720) and transmit and/or receive a signal. The signal may include control information and data. In addition, the transceiver (710) may receive the signal through a wireless channel and output the signal to the processor (720). The transceiver (710) may transmit a signal output from the processor (720) through the wireless channel.

The memory (730) may store the control information or the data included in a signal obtained by the user equipment (700). The memory (730) may be connected to the processor (720) and store at least one instruction or a protocol or a parameter for the proposed function, process, and/or method. The memory (730) may include read-only memory (ROM) and/or random access memory (RAM) and/or hard disk and/or CD-ROM and/or DVD and/or other storage devices.

Embodiments of the disclosure can also be embodied as a storage medium including instructions executable by a computer such as a program module executed by the computer. A computer readable medium can be any available medium which can be accessed by the computer and includes all volatile/non-volatile and removable/non-removable media.

Further, the computer readable medium may include all computer storage and communication media. The computer storage medium includes all volatile/non-volatile and removable/non-removable media embodied by a certain method or technology for storing information such as computer readable instruction code, a data structure, a program module or other data. Communication media may typically include computer readable instructions, data structures, or other data in a modulated data signal, such as program modules. In addition, computer-readable storage media may be provided in the form of non-transitory storage media.

The ‘non-transitory storage medium’ is a tangible device and only means that it does not contain a signal (e.g., electromagnetic waves). This term does not distinguish a case in which data is stored semi-permanently in a storage medium from a case in which data is temporarily stored. For example, the non-transitory recording medium may include a buffer in which data is temporarily stored.

According to an embodiment of the disclosure, a method according to various disclosed embodiments may be provided by being included in a computer program product. The computer program product, which is a commodity, may be traded between sellers and buyers. Computer program products are distributed in the form of device-readable storage media (e.g., compact disc read only memory (CD-ROM)), or may be distributed (e.g., downloaded or uploaded) through an application store or between two user devices (e.g., smartphones) directly and online. In the case of online distribution, at least a portion of the computer program product (e.g., a downloadable app) may be stored at least temporarily in a device-readable storage medium, such as a memory of a manufacturer's server, a server of an application store, or a relay server, or may be temporarily generated.

The present disclosure provides the following advantages:
1) The present disclosure provides a user with surround sound experience in a variable capability multi-speaker environment.
2) The present disclosure obtains the UWB data to detect the position of the speakers. Additionally, the present disclosure makes the common equalizer for each of the speakers. This helps in calibrating the sound parameters among the speakers and then sending the channels to the speakers after adjustments.
3) In the present disclosure, the channels are refined based on the position of the speakers which enhances the surround sound effect.
4) In the present disclosure, homogeneous frequencies are played, and unwanted frequencies are suppressed between the variable capability multi-speaker environment.
5) Unlike, the existing technologies, the present disclosure does not down-mixes the audio signal in which front and rear characteristics of sound is lost. Rather, in the present disclosure, the existing channels are equalized and refined based on the positions of the speaker.

While specific language has been used to describe the present subject matter, any limitations arising on account thereto, are not intended. As would be apparent to a person in the art, various working modifications may be made to the method in order to implement the inventive concept as taught herein. The drawings and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment.

The specific examples provided to explain the embodiments according to the present disclosure are merely a combination of each standard, method, detail method, and operation, and the various embodiments described herein can be performed through a combination of at least two or more techniques among the various techniques described. In addition, at this time, it can be performed according to a method determined through a combination of one or at least two or more of the aforementioned techniques. For example, it may be possible to perform a combination of parts of the operation of one embodiment with parts of the operation of another embodiment.

What is claimed is:

1. A method performed by a user equipment (UE) for enhancing surround sound in an environment of a plurality of speakers, the method comprising:
generating a position map of the plurality of speakers based on respective position coordinates of each of the plurality of speakers;
determining one or more equalized audio channels associated with each of the plurality of speakers, wherein the one or more equalized audio channels indicate homogeneous frequencies associated with each of the plurality of speakers;
allocating the one or more equalized audio channels to one or more of the plurality of speakers based on the position map; and
adjusting an audio intensity of the plurality of speakers based on the position map.

2. The method of claim 1, wherein the generating the position map comprises:
obtaining an ultra-wide band (UWB) data for the plurality of speakers;
calculating a respective angle of arrival and a respective distance for each of the plurality of speakers based on the UWB data; and
determining the respective position coordinates of each of the plurality of speakers based on the respective angle of arrival and the respective distance for each of the plurality of speakers.

3. The method of claim 1, wherein the position map is generated based on an orientation of the UE being connected with the plurality of speakers for transmitting a sound signal.

4. The method of claim 1, wherein the determining the one or more equalized audio channels comprises:
creating chirp sound signals;
controlling each of the plurality of speakers to play the chirp sound signals;
recording output signals of each of the plurality of speakers based on the chirp sound signals;
calculating inter-correlation frequency data based on the output signal of each of the plurality of speakers; and
determining the one or more equalized audio channels based on the calculated inter-correlation frequency data, wherein the one or more equalized audio channels indicate the homogeneous frequencies associated with each of the plurality of speakers.

5. The method of claim 4, wherein
the homogeneous frequencies are played as an audio signal on each of the plurality of speakers present in the environment; and
one or more unwanted frequencies are suppressed in each of the plurality of speakers in the environment.

6. The method of claim 4, wherein the chirp sound signal ranges from 20 Hz to 20 KHz.

7. The method of claim 1, wherein the allocating the one or more equalized audio channels comprises:
determining a number of channels available in the environment for the plurality of speakers;
determining a number of the plurality of speakers and a respective angular position of each of the plurality of speakers with respect to the UE;
determining a function associated with each of the plurality of speakers indicating a configuration of each of the plurality of speakers based on the number of channels and angular positions of the plurality of speakers, wherein the angular positions of the plurality of speakers comprises the respective angular position of each of the plurality of speakers with respect to the UE; and
based on the function associated with each of the plurality of speakers, allocating the one or more equalized audio channels to one or more each of the plurality of speakers.

8. The method of claim 2, wherein the adjusting the audio intensity of the plurality of speakers comprises:
determining a respective gain value of each of the plurality of speakers;
obtaining the respective distance of each of the plurality of speakers;
calculating a respective audio intensity of each of the plurality of speakers based on the respective gain value and the respective distance of each of the plurality of speakers; and
adjusting the respective audio intensity of each of the plurality of speakers to obtain an equal audio intensity for each of the plurality of speakers.

9. A user equipment (UE) for enhancing surround sound in an environment of a plurality of speakers, the UE comprising:
at least one processor; and
memory storing one or more instructions, when executed by the at least one processor individually or collectively, cause the UE to:
generate a position map of the plurality of speakers based on respective position coordinates of each of the plurality of speakers,
determine one or more equalized audio channels associated with each of the plurality of speakers, wherein the one or more equalized audio channels indicate a homogeneous frequencies associated with each of the plurality of speakers,
allocate the one or more equalized audio channels to one or more of the plurality of speakers based on the position map, and
adjust an audio intensity of the plurality of speakers based on the position map.

10. The UE of claim 9, wherein the one or more instructions, when executed by the at least one processor individually or collectively, further cause the UE to:
obtain an ultra-wide band (UWB) data for the plurality of speakers,
calculate respective angle of arrival and a respective distance for each of the plurality of speakers based on the UWB data, and
determine the respective position coordinates of each of the plurality of speakers based on the respective angle of arrival and the respective distance for each of the plurality of speakers.

11. The UE of claim 9, wherein the one or more instructions, when executed by the at least one processor individually or collectively, further cause the UE to:
generate the position map of the plurality of speakers based on an orientation of the UE being connected with the plurality of speakers for transmitting a sound signal.

12. The UE of claim 9, wherein the one or more instructions, when executed by the at least one processor individually or collectively, further cause the UE to:
create chirp sound signals,
control each of the plurality of speakers to play the chirp sound signals,
record output signals of each of the plurality of speakers based on the chirp sound signals,
calculate inter-correlation frequency data based on the output signals of each of the plurality of speakers, and
determine the one or more equalized audio channels based on the calculated inter-correlation frequency data, wherein the one or more equalized audio channels indicate the homogeneous frequencies associated with each of the plurality of speakers.

13. The UE of claim 12, wherein
the homogeneous frequencies are played as an audio signal on each of the plurality of speakers present in the environment; and
one or more unwanted frequencies are suppressed in each of the plurality of speakers in the environment.

14. The UE of claim 12, wherein the chirp sound signal ranges from 20 Hz to 20 KHz.

15. The UE of claim 9, wherein the one or more instructions, when executed by the at least one processor individually or collectively, further cause the UE to:
determine a number of channels available in the environment for the plurality of speakers,
determine a number of the plurality of speakers and a respective angular position of each of the plurality of speakers with respect to the UE,
determine a function associated with each of the plurality of speakers indicating a configuration of each of the plurality of speakers based on the number of channels and angular positions of the plurality of speakers, wherein the angular positions of the plurality of speakers comprises the respective angular position of each of the plurality of speakers with respect to the UE; and
based on the function associated with each of the plurality of speakers, allocate the one or more equalized audio channels to one or more of the plurality of speakers.

16. The UE of claim 10, wherein the one or more instructions, when executed by the at least one processor individually or collectively, further cause the UE to:
determine a respective gain value of each of the plurality of speakers,
obtain the respective distance of each of the plurality of speakers,
calculate a respective audio intensity of each of the plurality of speakers based on the respective gain value and the respective distance of each of the plurality of speakers, and
adjust the respective audio intensity of each of the plurality of speakers to obtain an equal audio intensity for each of the plurality of speakers.

17. A non-transitory computer readable medium storing instructions that, when executed by at least one processor individually or collectively, cause an electronic device to:
generate a position map of the plurality of speakers based on respective position coordinates of each of the plurality of speakers,
determine one or more equalized audio channels associated with each of the plurality of speakers, wherein the one or more equalized audio channels indicate a homogeneous frequencies associated with each of the plurality of speakers,
allocate the one or more equalized audio channels to one or more of the plurality of speakers based on the position map, and
adjust an audio intensity of the plurality of speakers based on the position map.
